(19) United States
(12) Patent Application Publication
(10) Pub. No.: US 2004/0090122 A1
(43) Pub. Date: May 13, 2004

(54) Method for local security locking of a vehicle door

(76) Inventors: Emmanuel Huber, Chateauneuf sur Loire (FR); Jean Marc Belmond, St Jean Le Blanc (FR); Frederic Burkat, Bouzy La Foret (FR)

Correspondence Address: CARLSON, GASKEY & OLDS, P.C., 400 WEST MAPLE ROAD, SUITE 350, BIRMINGHAM, MI, 48009, US

(21) Appl. No.: 10/657,731

(22) Filed: Sep. 8, 2003

(30) Foreign Application Priority Data
Sep. 6, 2002 (FR) 02 11 144

(51) Int. Cl. B60R 25/00; H01H 47/22

(52) U.S. Cl. 307/10.2

(57) ABSTRACT

A vehicle door controller connected to various door components and to a bus is programmed to reassign at least one vehicle occupant-operable regulator to actuate a latch mechanism motor if a fault is detected in the bus. The regulator and door controller may be used to perform security locking even when the bus is unable to carry signals to the latch mechanism.

### REFERENCE TO RELATED APPLICATION

The present invention claims the benefit of French Patent Application No. 02 11 144, filed Sep. 6, 2002.

### TECHNICAL FIELD

The present invention relates to vehicle doors, and more specifically to security or anti-theft locking of vehicle doors.

### BACKGROUND OF THE INVENTION

Currently-known vehicles include a multiplexed bus that transmits information between various components of vehicle sensors, actuators and other similar components. A typical bus is a CAN (controller area network) bus and is usually disposed inside a vehicle door.

Typically, the multiplexed bus is connected to a door controller, which is in turn connected to various door components accessible using a multiplexer/demultiplexer. Possible door components include, for example in the case of a front door of an Audi® A4 automobile, a lock whose operation is controllable by signals sent through the bus, a window lifter, a first contact in the lock for detecting security locking of the door and a second contact in the lock for detecting when the door is closed. The lock and window lifter motors are controlled by the bus via the door controller. The door security locking information supplied by the first contact together with the information on the closed status of the door supplied by the second contact are transmitted on the bus via the door controller. This type of system usually leaves out a button or rocker for mechanically actuating and releasing security locking because the security locking is conducted entirely via electronic components.

This proposed structure has the advantage of limiting the number of cables installed in the vehicle. One disadvantage is that a fault on the bus will paralyze operation of the various components inside the vehicle door. Such a fault can, for example, result from one of the bus wires being cut inside the door or at some other place in the vehicle, a short circuit on the bus, or a defective component connected to the bus that causes the bus being short-circuited. Thus, if a system fault occurs, it is no longer possible to electrically control security locking of the door even if the lock is still fully operational.

There is consequently a need for a solution that allows security locking even if there is a fault in the bus.

### SUMMARY OF THE INVENTION

One embodiment of the present invention is directed to a vehicle door, comprising a bus, a door controller connected to the bus and to components of the door. The door components include at least a latch mechanism adapted to be security locked from the door controller upon receiving a command from the bus and a regulator operated by a vehicle occupant. The door controller is adapted to detect incorrect operation of the bus and, upon detection of the incorrect operation, to security lock the latch mechanism upon operation of the regulator by a vehicle occupant.

The advantage of this embodiment is that it allows a door to be security locked even if there is a fault on the multiplexed bus. In particular, security locking is still possible even if there is no inside door locking button or rocker allowing the lock to be security locked via mechanical means.

The vehicle occupant regulator can comprise an inside door opening regulator. If one of the components is a window lifter, the vehicle occupant regulator can comprise the regulator for operating the window lifter.

Another embodiment of the invention is directed to a door controller having a first terminal that connects the door controller to a bus, a second terminal that connects the door controller to a motor for security locking a door latch mechanism, a third terminal that connects the door controller to a regulator operable by a vehicle occupant, detection logic that detects incorrect operation of the bus linked to the bus connection terminal, and security locking logic adapted to issue a security locking command to a connecting terminal of the motor. The motor performs security locking (which includes, for example, anti-theft locking) of a door latch mechanism when a command initiated by operation of the regulator is applied to a regulator connecting terminal while the detection logic is detecting incorrect operation of the bus.

The invention is also directed to a method for local security locking of an automobile vehicle door latch mechanism, having a bus, a door controller connected to the bus, a latch mechanism connected to the door controller and an occupant-operable regulator connected to the door controller. One embodiment of the inventive method comprises using the door controller to detect incorrect operation of the bus and security locking the latch mechanism via the door controller if the regulator operable by a vehicle occupant is actuated during the time incorrect bus operation is detected.

The vehicle occupant-operable regulator can be a regulator for operating a window lifter, the security locking step being performed upon actuation of the window lifter regulator when the incorrect operation is also detected. The regulator can also be an inside door opening regulator, in which case the security locking step is performed if the inside opening regulator is actuated while the incorrect operation is also detected.

Further characteristics and advantages of the invention will become more clear from the detailed description which follows. Several embodiments of the invention are described below and are provided solely by way of example and with reference to the attached drawings.

### BRIEF DESCRIPTION OF THE DRAWINGS

FIG. 1 is a representative diagram of a door in which one embodiment of the invention can be implemented;

FIG. 2 is a flow chart of a first example of the method according to an embodiment of the invention;

FIG. 3 is a flow chart of a second example of the method according to an embodiment of the invention.

### DETAILED DESCRIPTION OF PREFERRED EMBODIMENTS

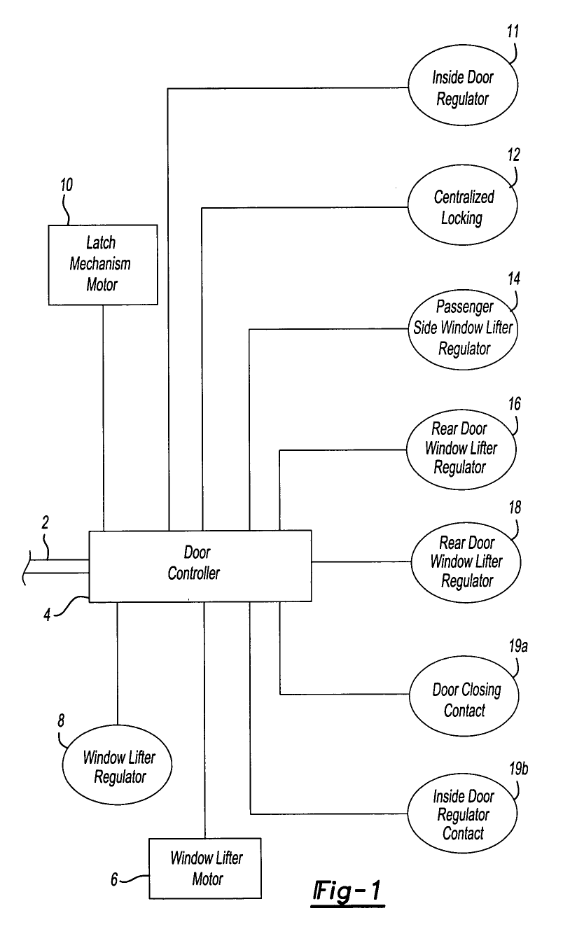

FIG. 1 is a diagrammatic view of a vehicle door in which the invention can be implemented. The example described below is directed to a driver-side door, but the diagram is applicable for any vehicle door. As shown in FIG. 1, the inventive system includes a multiplexed bus 2 connected to a door controller 4. FIG. 1 also shows parts of an electric window lifter, more precisely a window lifter drive motor 6 together with a regulator 8 for operating the window lifter drive motor 6. FIG. 1 also shows a latch mechanism motor 10. These various components are connected to the door controller 4. The door controller 4 consequently has terminals for connecting the bus 2 to other components.

In a vehicle such as the Audi® A4 discussed above, a rear door is only fitted with the components described above along with appropriate sensors. Other vehicles and other vehicle doors may also incorporate fewer than all of the components shown in FIG. 1. With respect to a driver's door of, for example, the same Audi® A4, the door may include other components such as an inside door regulator 11, a centralized locking control 12, a regulator for operating of the window lifter of a passenger door 14 and regulators for operating the window lifters of the rear doors 16, 18.

During normal operation, as explained above, a control action initiated by an occupant of the vehicle via a regulator 8, 12, 14, 16 or 18 is transmitted to door controller 4, which sends signals onto the bus 2. In response, the door controller 4 receives a motor operating instruction from the bus 2 and transmits the motor operating instruction to the corresponding motor 6, 10 to operate the motor.

As explained above, if there is a fault or other problem with the bus 2, this normal mode of operation does not allow the latch mechanism motor 10 to be operated in response to regulator operation by the vehicle occupants. More particularly, any fault in the bus 2 will prevent the motor operating instruction from reaching either motor 6, 10 via the bus 2.

In one embodiment of the invention, it is still possible to security lock the door, even if the multiplexed bus is not operating correctly, by local action on a local regulator on the vehicle door. In other words, the invention reassigns local regulators to allow security locking of the latch mechanism. This is made possible by connecting the various door components to the door controller. Because the door controller 4 includes logic circuits (e.g., typically a customized processor or programmable logic), it can be programmed to reassign the security locking function to respond directly to operation of the regulator 8, 12, 14, 16 or 18, bypassing the defective bus 2 if the bus is not operating correctly.

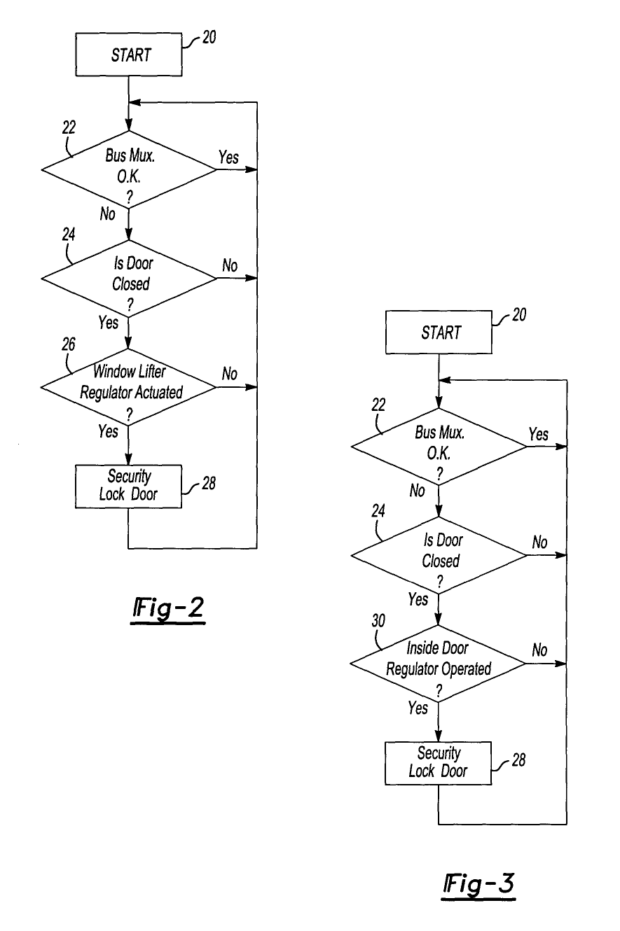

FIG. 2 is a flow diagram illustrating a method according to one embodiment of the invention. In one embodiment, the method shown in the flow diagram is implemented by a system program in the door controller 4 in a door of the type shown in FIG. 1. Note that the door shown in FIG. 1 may contain a contact 19a for detecting closing of the door. Generally, in this example, if the bus 2 is not operating correctly, security locking of the door can still be conducted by actuating the window lifter regulator 8.

More specifically, operation of the door controller 4 starts (block 20). Note that the door controller 4 can be permanently operating if it has a local power source (e.g., if the door includes a battery) or if it connected to the vehicle battery (not shown). The operation of the multiplexed bus is then tested at a suitable frequency (block 22); if the bus is operating normally, the program loops back and continues testing the multiplexed bus (block 22).

If the bus 2 is not operating normally, however, the method then determines whether the vehicle door is closed (block 24). In one embodiment, the door controller 4 simply interrogates the door closing detection contact 19a to determine this. If the door is open, the program loops back to block 22; if, on the other hand, the door controller 4 detects that the door is closed, the process passes to block 26.

Once the door controller 4 detects that the multiplexed bus 2 is faulty (block 22) and that the vehicle door is closed (block 24), the door controller 4 then checks whether the regulator 8 for operating a window lifter is actuated (block 26). This is done simply by the door controller 4 in the same manner as that used when the bus is operating normally. In this example, however, any command delivered by the window lifter regulator 8 is not transmitted over the bus 2 because, as noted above, it is faulty.

If the window lifter regulator is not actuated, the process goes back to block 22. If the window lifter regulator 8 is actuated while the bus 2 is not operating, however, the door controller 4 orders security locking of the door by instructing the latch mechanism motor 10 to operate. As noted above, the door controller 4 does not send this instruction over the bus 2; instead, the instruction received by the latch mechanism motor 10 is an instruction sent directly from the window lifter operating regulator 8 through the door controller 4 to the motor 10 and that is interpreted by the motor 10 as an instruction to security lock the latch mechanism (block 28). Once security locking has taken place, the process returns to monitoring the multiplexer bus (block 22).

Thus, as shown in FIG. 2, it is possible to security lock the latch mechanism even though the bus 2 is not operating. This allows, for example, the vehicle to be securely locked against theft even if the bus 2 is not operating. It therefore becomes possible to leave the vehicle with security locking in operation even if the vehicle has no mechanical system to operate the security locking function.

FIG. 2 only shows one example of the inventive method. Regulators other than the window lifter regulator 8 can be used to initiate security locking when the bus 2 is not operational. Window regulators have the advantage of being the most frequently present regulator in vehicle doors and are often provided in the absence of any other occupant controlled regulator. However, the invention is not limited solely to window lifter regulators 8.

The example of FIG. 2 can be further refined by adding functions that are initiated upon actuation of, for example, the window lifter regulator 8 by a vehicle occupant. For example, the window lifter regulator 8 could be employed not only for security locking the latch mechanism but also for closing the door window glass at the same time. One can, for example, proceed to close the vehicle window at the same time as the door is being security locked. One can also security lock the vehicle by operating the window lifter regulator twice. In other words, the invention covers any possible alternative to allow re-assigned regulators to be re-assigned by the door controller 4 when the bus 2 is no longer operating.

It will be understood that the door closing contact 19a in FIG. 1 and the door closing detection step (block 24) in FIG. 2 are purely optional. One could dispense with the door closing detection step, particularly if the latch mechanism can be security locked when the door is in an open position. Note that the return paths shown in FIGS. 2 and 3 can be changed so that the return loops at blocks 24 and 26 return to steps other than block 22. For example, the method could change the path within the loop for a “no” output from the decisions at blocks 24 and 26 to loop back to block 24 if “no” is output from block 24. The method could also loop to block 24 or block 26 if the output from block 26 is “no”. Similarly, after leaving block 28, the method could loop back to block 24, block 26 or block 28.

FIG. 3 shows a flow diagram according to another embodiment of the invention. Like the embodiment shown in FIG. 2, the flow diagram shown in FIG. 3 can be implemented by an operating program in the door controller 4. In one embodiment, the process shown in FIG. 3 corresponds to a door in which the door controller 4 is connected to a motor that security locks the door's latch mechanism and in which a regulator for opening the door from the inside 11 is provided along with an associated inside door regulator contact 19b that detects such operation. The inside door regulator contact 19b can be useful even when the door opening mechanism is mechanical rather than electrical. In the example of FIG. 3, actuation of the inside door regulator 11 to trigger its corresponding contact 19b leads to security locking of the latch mechanism.

The steps in the flow chart of FIG. 3 are identical to those in FIG. 2, except for block 26, which is replaced by block 30 in FIG. 3.

At block 30, it is assumed that the multiplexed bus 2 is not operating and that the vehicle door is closed. The door controller 4 then determines whether the inside door regulator is being operated over a sufficient length of travel to trigger its corresponding contact 19b. This is done simply from the controller 4 in the same way as when the bus 2 is operating normally without the necessity to transmit information over the bus 2. If the inside door regulator contact 19b indicates that the inside door regulator is not being operated, the process goes back to block 22. If the door controller 4 determines that the inside door regulator is being operated, however, the process passes to block 28 and security locks the door.

The method of FIG. 3 can be implemented even in a vehicle that does not have an electric window lifter regulator. FIG. 3 is one example where a vehicle occupant regulator other than a window lifter regulator can be used to security lock the latch mechanism through local reassignment of a vehicle occupant regulator by the door controller 4.

In the example of FIG. 3, like in FIG. 2, it will be understood that security locking only relates to the latch mechanism of the door involved because security locking is performed locally by the door controller 4. One can nevertheless security lock all the doors of a vehicle by proceeding with the operation from each one of the vehicle doors or by providing mechanisms that allow remote locking of some or all of the vehicle doors from one location.

The examples of operation in FIGS. 2 and 3 can be performed easily through suitable programming of the logic in the door controller 4. The programming can be performed in any known manner and can be, for example, built into the design of the door controller 4 or programmed subsequently. It is sufficient to add means for detecting incorrect operation of the bus 2 to the controller 4 logic for implementing security locking of the latch mechanism upon receiving a command from a local regulator 8, 12, 14, 16, 18 operated by a vehicle occupant. The detection logic detects a fault in the bus 2 connected to a bus connection terminal by analyzing signals received or sent by the controller at this terminal. When the detection logic detects incorrect bus operation, the security locking logic delivers a command to perform security locking to a terminal of the latch mechanism motor if the logic receives an instruction on the terminal connected to the local regulator means (i.e., the regulator operated by a vehicle occupant).

Detecting incorrect operation of the bus can be done simply by requiring the controller to send a command or interrogation on the bus 2, verifying the response received from a central vehicle controller or from the recipient of the command or the interrogation. If the bus controller receives no reply, it can conclude that the bus is no longer operating.

Obviously, the present invention is not limited to the embodiments described above by way of example. Note, for example, that the door described above can be construed to mean any opening part of the vehicle provided with a lock and at least one regulator or control for opening it. The example above also recites a multiplexed bus, but the invention can be applied in any door controller that receives instructions from a bus, regardless of whether the latter is fully multiplexed.

The description above also focuses on security locking of the latch mechanism; however, the invention can be implemented to conduct local release of the latch mechanism in the case of faulty operation by, for example, operating a window lifter regulator.

The above examples illustrate reassignment of a vehicle occupant regulator or control normally used to operate a window lifter or inside door regulator. Other controls could also be used. Further, reassignment can optionally be initiated upon closing of the door, if desired.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. A vehicle door latch control system, comprising:
a latch mechanism motor;
a bus;
at least one occupant-operable regulator;
a door controller connected to the latch mechanism motor, the bus and said at least one regulator, the door controller containing door controller logic that detects a fault in the bus and that assigns control of the latch mechanism motor to one of said regulators upon detection of the fault.

2. The system of claim 1, wherein the door controller logic operates the latch mechanism motor to a security locking state when the door controller detects actuation of the regulator.

3. The system of claim 1, wherein the door controller logic operates the latch mechanism motor to a latch release state when the door controller detects actuation of the regulator.

4. The system of claim 1, wherein said at least one occupant-operable regulator is at least one selected from the group consisting of an inside door regulator, a central locking regulator, and a window lifter regulator.

5. The system of claim 4, wherein said at least one occupant-operable regulator is the inside door regulator, and wherein the system further comprises an inside door regulator contact, wherein the door controller logic operates the latch mechanism motor when the fault is detected in the bus and when the inside door regulator contact indicates that the inside door regulator is actuated.

6. The system of claim 1, wherein the bus is a multiplexed bus.

7. The system of claim 1, further comprising a door closing contact, wherein the door controller logic operates the latch mechanism motor when a fault is detected in the bus and when the door closing contact indicates that the vehicle door is closed.

8. A door controller for a vehicle door, comprising:
a first terminal to connect the door controller to a bus;
a second terminal to connect the door controller to a latch mechanism motor;
at least one regulator terminal to connect the door controller to at least one occupant-operable regulator;
detection logic that detects a fault in a bus connected to the bus connection terminal; and
security locking logic that detects operation of at least one occupant-operable regulator and issues a security locking command to the latch mechanism motor to perform security locking of a door latch mechanism if the detection logic detects the fault in the bus.

9. A method for controlling a vehicle door latch system mechanism having a latch mechanism, a bus, and at least one occupant-operable regulator, the method comprising:
detecting a fault in the bus;
assigning control of the latch mechanism to one of said regulators upon detection of the fault; and
operating the latch mechanism when the regulator is actuated.

10. The method of claim 9, wherein the operating step comprises security locking the latch mechanism.

11. The method of claim 9, wherein the operating step comprises releasing the latch mechanism.

12. The method of claim 9, further comprising detecting actuation of an inside door regulator, wherein the operating step is conducted when the fault is detected in the bus and when the actuation of the inside door regulator is detected.

13. The method of claim 9, further comprising detecting a closed door, wherein the door controller logic operates the latch mechanism motor when a fault is detected in the bus and when the closed door is detected.

14. The method of claim 9, in which the regulator is a window lifter regulator, and wherein the latch mechanism operating step is performed if the window lifter regulator is actuated.

15. The method of claim 9, in which the regulator is an inside door opening regulator, and wherein the latch mechanism operating step is performed if the inside door opening regulator is actuated.
